(19) United States
(12) Patent Application Publication
(10) Pub. No.: US 2013/0035857 A1
(43) Pub. Date: Feb. 7, 2013

(54) CONTROL COMPUTER AND ELECTRONIC MAP ROUTE PLANNING METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/484,285

(22) Filed: May 31, 2012

(30) Foreign Application Priority Data
Aug. 1, 2011 (TW) 100127281

(51) Int. Cl. G01C 21/00

(52) U.S. Cl. 701/533

(57) ABSTRACT

An exemplary method for planning a route in an electronic map uses a control computer. A first updated electronic map is produced. The first updated electronic map records a number of moving objects actually at each of locations represented on the electronic map, and a current position of a user of a handheld device. The moving objects are those detected by image capturing devices actually at the physical locations that are represented on the electronic map. Then a start position and an end position input on the first updated electronic map are received from the handheld device, and an optimized route from the start position to the end position is determined. Then a second updated electronic map is produced by recording the optimized route on the first updated electronic map, and the second updated electronic map is sent to the handheld device.

### BACKGROUND

1. Technical Field

Embodiments of the present disclosure relate to navigation technology, and particularly to a control computer and a method for planning a route on an electronic map.

2. Description of Related Art

In overland navigation, the shortest route between a selected start position and a selected end position can be determined on an electronic map such as an electronic road map. However, if the shortest route includes a lots of vehicles or pedestrians, more travelling time may be expended than if other routes which include fewer vehicles or pedestrians are used. Therefore, an efficient method for planning a route on an electronic map is desired.

### BRIEF DESCRIPTION OF THE DRAWINGS

FIG. 1 is a schematic diagram of one embodiment of a handheld device communicatively connected with a control computer, and showing an associated application environment that includes a plurality of image capturing devices.

FIG. 2 is a schematic diagram of one embodiment of the handheld device of FIG. 1, the handheld device including a route planning client system.

FIG. 3 is a schematic diagram of one embodiment of the control computer of FIG. 1, the control computer including a route planning service system.

FIG. 4 is a schematic diagram of function modules of the route planning client system of the handheld device of FIG. 2.

FIG. 5 is a schematic diagram of function modules of the route planning service system of the control computer of FIG. 3.

FIG. 6 is a flowchart of a first embodiment and a second embodiment of a method for planning a route in an electronic map using the handheld device and the control computer of FIG. 1.

FIG. 7 is a flowchart of a third embodiment of a method for planning a route in an electronic map using the handheld device and the control computer of FIG. 1.

FIG. 8 is a schematic diagram of an example of an electronic map produced according to the method of FIG. 6, the electronic map including locations of the image capturing devices of FIG. 1.

FIG. 9 is a schematic diagram of two example displays of a user interface of the route planning client system of the handheld device of FIG. 2.

FIG. 10 is a schematic diagram of an example of a first updated electronic map produced according to the method of FIG. 6.

FIG. 11 is a schematic diagram of an example of a second updated electronic map produced according to the method of FIG. 6.

FIG. 12 is a schematic diagram of an example of setting a start position and an end position on the first updated electronic map of FIG. 10, according to the method of FIG. 6.

FIG. 13 is a schematic diagram of an example of a third updated electronic map produced according to the method of FIG. 6.

FIG. 14 is a schematic diagram of an example of a fourth updated electronic map produced according to the method of FIG. 7.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc (CD), a digital versatile disc (DVD), a tape drive or another suitable storage medium.

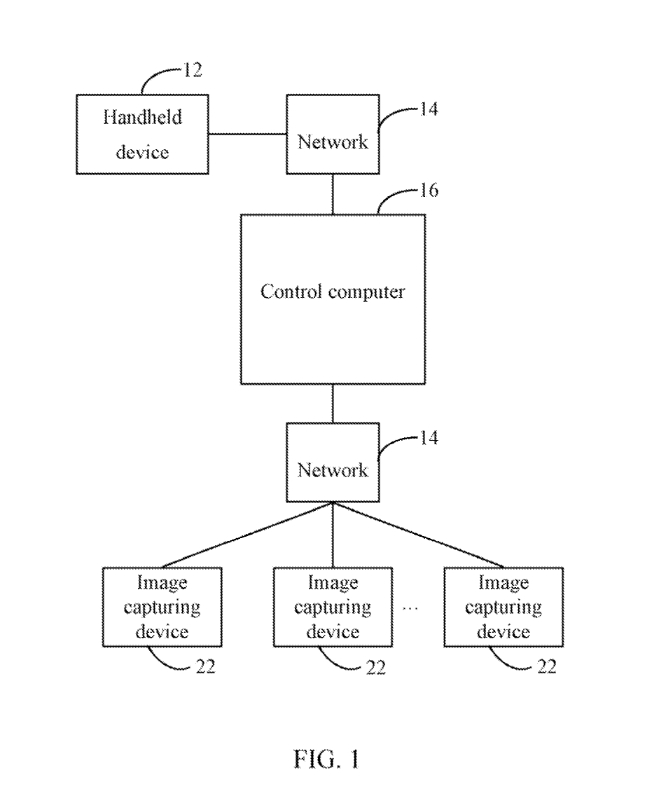

FIG. 1 is a schematic diagram showing one embodiment of a handheld device 12 communicatively connected with a control computer 16 through a network 14. The control computer 16 is further connected with a plurality of image capturing devices 22 through the network 14. For example, the network 14 may be the Internet, an intranet, or any other suitable network, and the image capturing devices 22 may be speed dome cameras or pan/tilt/zoom (PTZ) cameras.

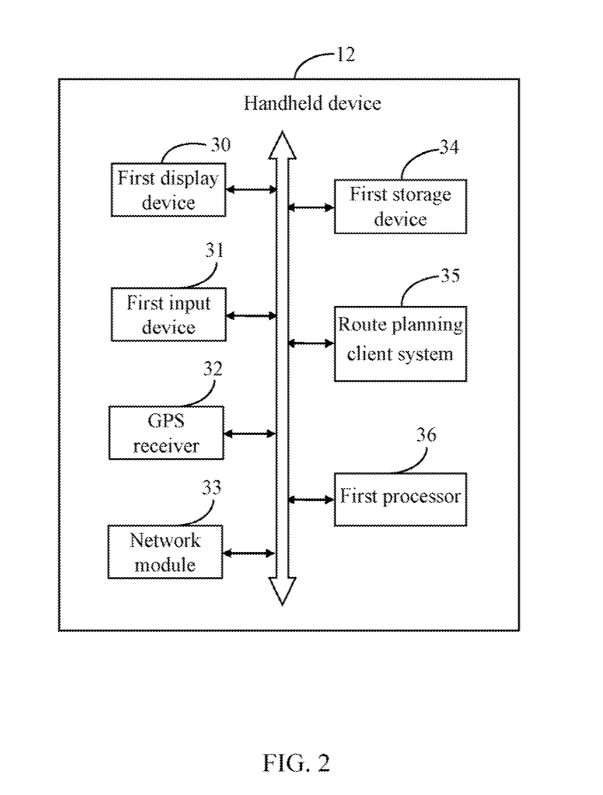

FIG. 2 is a schematic diagram of one embodiment of the handheld device 12. The handheld device 12 includes a route planning client system 35, which is for sending a route planning request to the control computer 16, and for receiving an optimized route determined (calculated) by the control computer 16. The handheld device 12 further includes a first display device 30, a first input device 31, a global positioning system (GPS) receiver 32, a wireless network communication module (hereinafter referred to as “network module”) 33, a memory (e.g., a first storage device 34), and at least one processor (e.g., a first processor 36). The handheld device 12 may be a smart phone, a personal digital assistant (PDA), or any other suitable communication device. FIG. 2 illustrates only one example of the handheld device 12. In other embodiments, the handheld device 12 may include more or fewer components than illustrated; or a different configuration of the various components may exist in other embodiments.

The first display device 30 may be a touch sensitive screen (e.g., a capacitive touch sensitive screen), and the first input device 31 may be a stylus used for input.

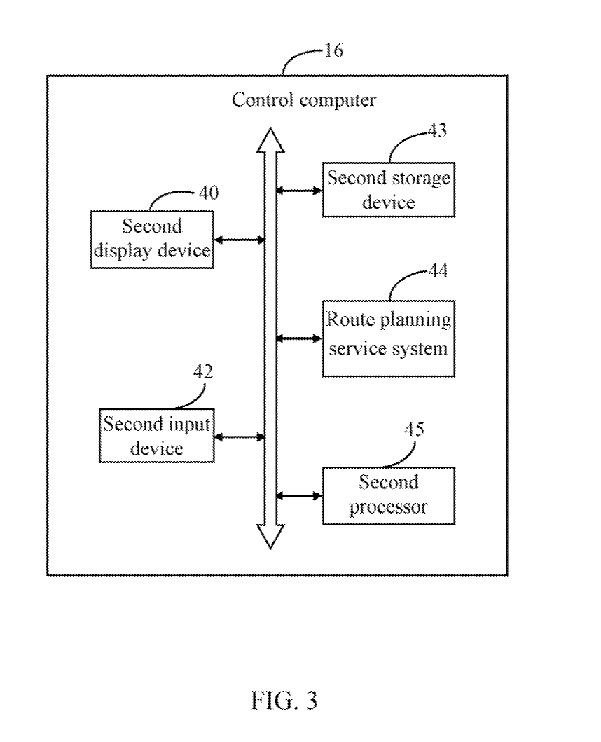

FIG. 3 is a schematic diagram of one embodiment of the control computer 16. The control computer 16 includes a route planning service system 44, which is for receiving a route planning request from the handheld device 12, for determining an optimized route according to a selected start position and a selected end position on an electronic map, and for sending the optimized route to the handheld device 12. Typically, the electronic map is an electronic road map. The control computer 16 further includes a second display device 40, a second input device 42, a memory (e.g., a second storage device 43), and at least one processor (e.g., a second processor 45). The control computer 16 may be a personal computer, a server, or any other suitable computing device. FIG. 3 illustrates only one example of the control computer 16. In other embodiments, the control computer 16 may include more or fewer components than illustrated; or a different configuration of the various components may exist in other embodiments.

The second display device 40 may be a liquid crystal display (LCD) or a cathode ray tube (CRT) display, and the second input device 42 may be a mouse, a keyboard, a touch screen, and/or a touchpad used for input.

In one embodiment, the route planning client system 35 may include computerized instructions in the form of one or more programs that are executed by the first processor 36 and stored in the first storage device 34. Further, the route planning service system 44 may include computerized instructions in the form of one or more programs that are executed by the second processor 45 and stored in the second storage device 43. A detailed description of the route planning client system 35 and the route planning service system 44 is given below.

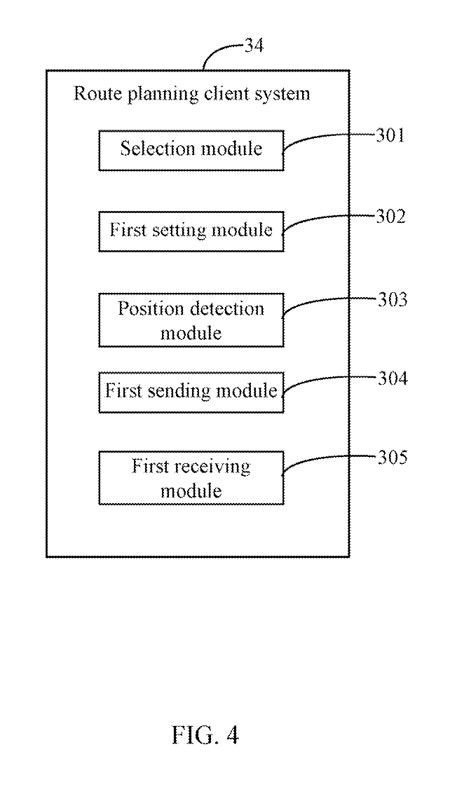

FIG. 4 is a schematic diagram of function modules of the route planning client system 35 included in the handheld device 12. In one embodiment, the route planning client system 35 may include one or more function modules, for example, a selection module 301, a first setting module 302, a position detection module 303, a first sending module 304, and a first receiving module 305.

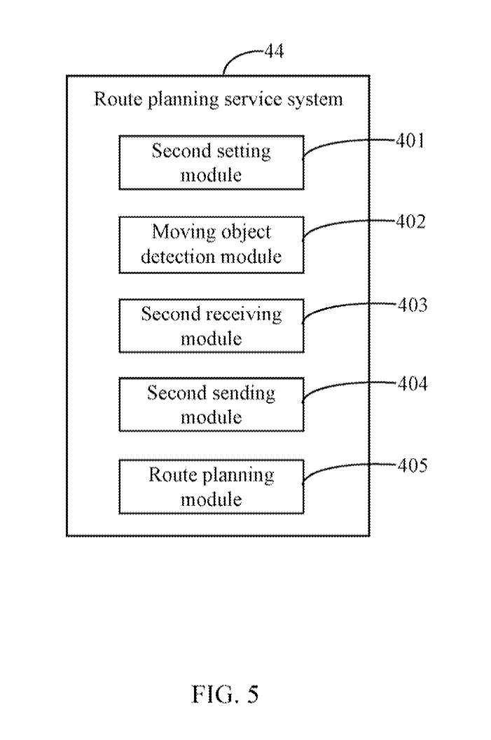

FIG. 5 is a schematic diagram of function modules of the route planning service system 44 included in the control computer 16. In one embodiment, the route planning service system 44 may include one or more function modules, for example, a second setting module 401, a moving object detection module 402, a second receiving module 403, a second sending module 404, and a route planning module 405.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable mediums include CDs, DVDs, Blu-Ray discs, Flash memory, and hard disk drives.

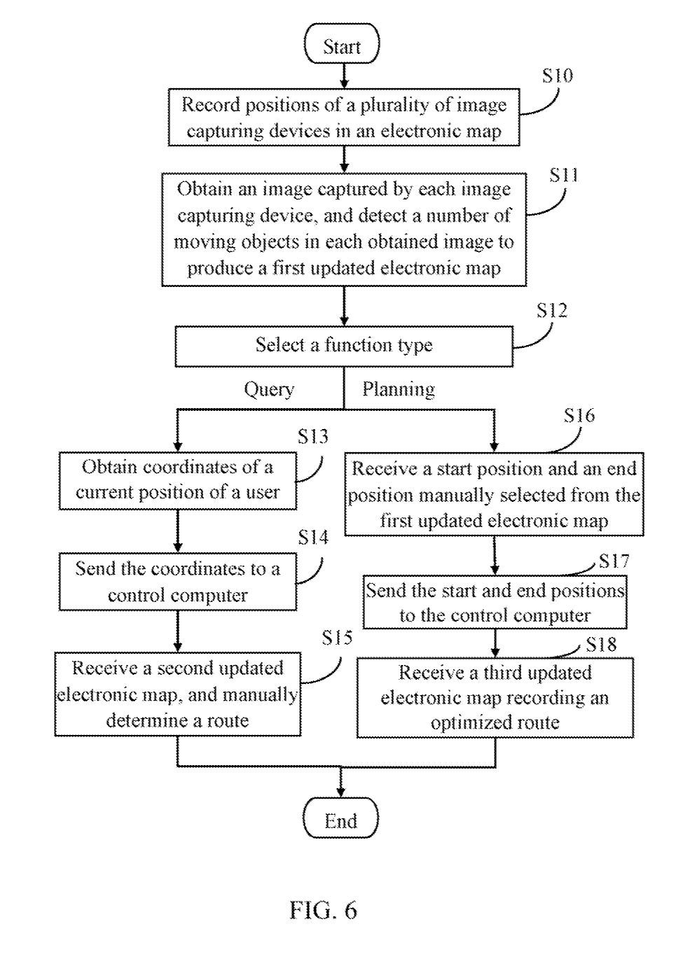

FIG. 6 is a flowchart of a first embodiment and a second embodiment of a method for planning a route on an electronic map using the handheld device 12 and the control computer 16. Depending on the embodiment, additional steps may be added, others removed, and the ordering of the steps may be changed.

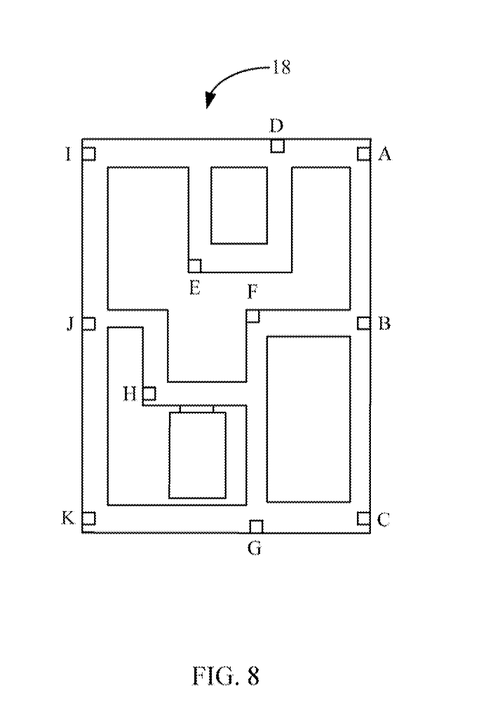

In step S10, the second setting module 401 records positions of the image capturing devices 22 in a plurality of monitored areas of an electronic map 18. As shown in FIG. 8, the electronic map 18 includes the image capturing devices “A”, “B”, “C”, “D”, “E”, “F”, “G”, “H”, “I”, “J”, and “K”.

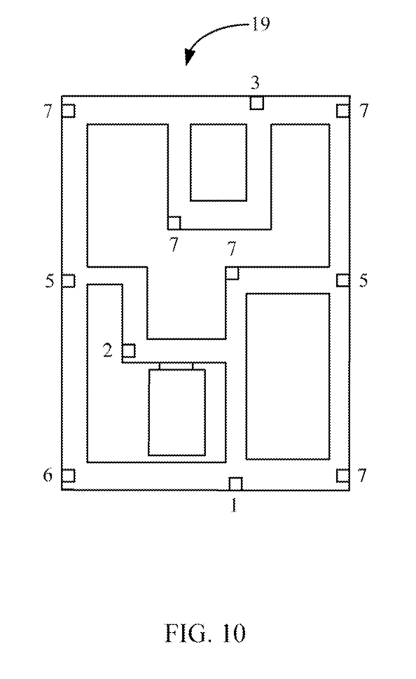

In step S11, the moving object detection module 402 obtains an image of the monitored area captured by each image capturing device 22 periodically (e.g., every 5 minutes), detects a number of moving objects in each obtained image, and produces a first updated electronic map 19 by recording the number of moving objects at each monitored area. For example, referring to FIG. 10, the number of moving objects in the monitored area of image capturing device “A” is 7, and the number of moving objects in the monitored area of image capturing device “G” is 1. In one embodiment, the moving objects include, but are not limited to, vehicles or persons, which are detected using a vehicle license plate recognition method or a pedestrian detection method. For example, the pedestrian detection method may be an adaptive boosting (aka AdaBoost) algorithm or a template matching method.

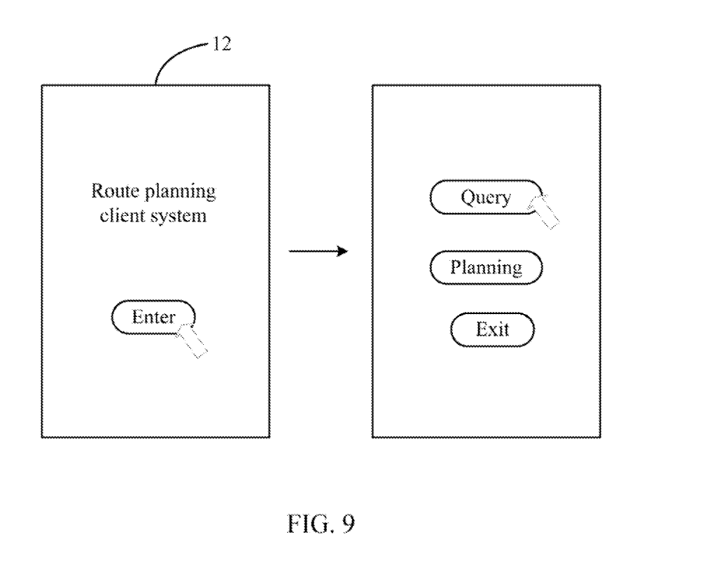

In step S12, the selection module 301 receives a function type instruction selected by a user of the handheld device 1. For example, as shown in FIG. 9, the selectable function types include a query function and a route planning function. If the query function is selected, steps S13-S15 (i.e., the first embodiment) are executed. If the route planning function is selected, steps S16-S18 (i.e., the second embodiment) are executed. FIG. 9 shows the query function being selected, as an example.

If the query function in step S12 is selected, then in step S13, the position detection module 303 obtains coordinates of a current position of the user using the GPS receiver 32 of the handheld device 12.

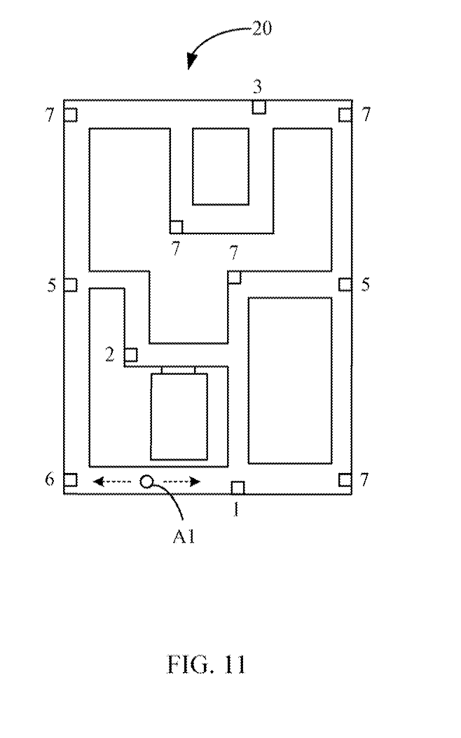

In step S14, the first sending module 304 sends the coordinates of the current position of the user to the control computer 16 through the network module (e.g., a WiFi module) 33 of the handheld device 12. The second receiving module 403 receives the coordinates of the current position of the user from the handheld device 12, produces a second updated electronic map 20 by recording the coordinates of the current position of the user on the first updated electronic map 19, and sends the second updated electronic map 20 to the handheld device 12. For example, as shown in FIG. 11, “A1” represents the current position of the user.

In step S15, the first receiving module 305 receives the second updated electronic map 20 from the control computer 16 through the network module 33, and displays the second updated electronic map 20 on the first display device 30 of the handheld device 12. As described above, the second updated electronic map 20 records the number of moving objects at each monitored area and also indicates the current position of the user.

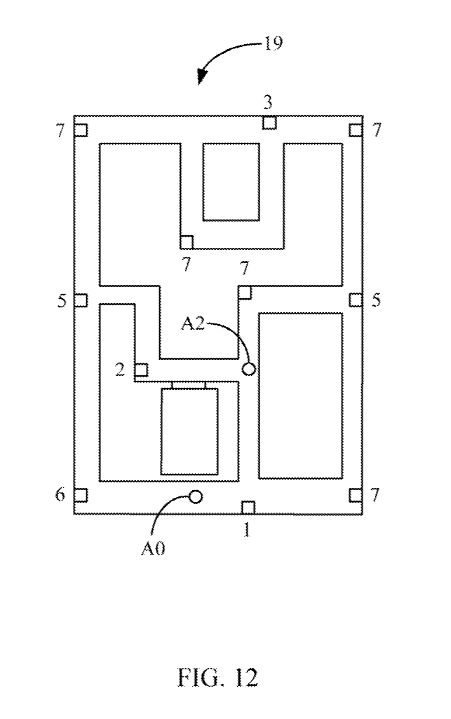

If the route planning function in step S12 is selected, then in step S16, the first setting module 302 obtains the first updated electronic map 19 from the control computer 16 through the network module 33, and receives a start position and an end position input on the first updated electronic map 19 by the user. As shown in FIG. 12, “A0” represents the start position selected by the user, and “A2” represents the end position selected by the user. In another example, the start position selected by the user may be the same as the current position “A1” of the user (which is seen in FIG. 11).

In step S17, the first sending module 304 sends the start position and the end position to the control computer 16 through the network 14.

In step S18, the second receiving module 403 receives the start position and the end position from the handheld device 12. The route planning module 405 determines an optimized route from the start position to the end position, and produces a third updated electronic map 21 by recording the start position, the end position and the optimized route on the first updated electronic map 19. Then, the second sending module 404 sends the third updated electronic map 21 to the handheld device 12 through the network 14. In some embodiments, the route planning module 405 may highlight the optimized route on the third updated electronic map 21.

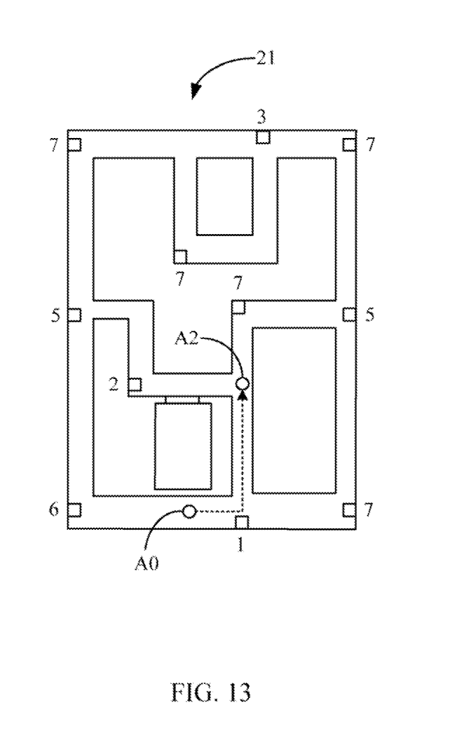

The first receiving module 305 receives the third updated electronic map 21 from the control computer 16, and displays the third updated electronic map 21 on the first display device 30. As described above, the third updated electronic map 21 records the optimized route from the start position to the end position. In one embodiment, the optimized route is a planned route which includes the lowest number of moving objects from the start position to the end position. For example, as shown in FIG. 13, the broken line from the start position “A0” to the end position “A2” represents the optimized route.

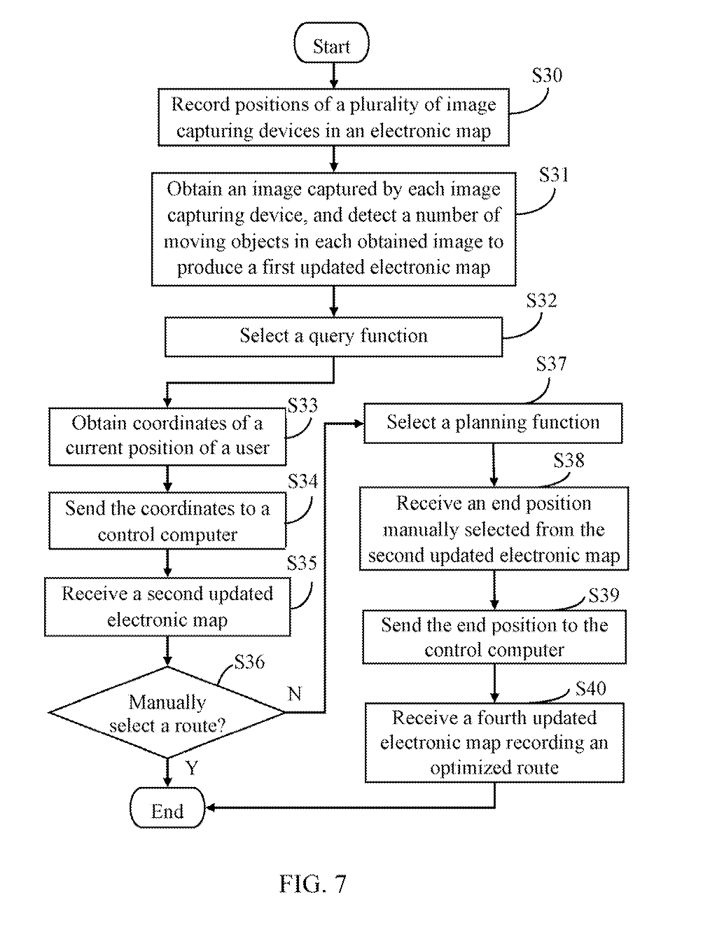

FIG. 7 is a flowchart of a third embodiment of a method for planning a route on an electronic map using the handheld device 12 and the control computer 16. Depending on the embodiment, additional steps may be added, others removed, and the ordering of the steps may be changed.

In step S30, the second setting module 401 records positions of the image capturing devices 22 in a plurality of monitored areas of an electronic map 18.

In step S31, the moving object detection module 402 obtains an image of the monitored area captured by each image capturing device 22 periodically (e.g., every 5 minutes), detects a number of moving objects in each obtained image, and produces a first updated electronic map 19 by recording the number of moving objects at each monitored area.

In step S32, the selection module 301 receives a query function instruction selected by the user of the handheld device 1.

In step S33, the position detection module 303 obtains coordinates of a current position of the user using the GPS receiver 32 of the handheld device 12.

In step S34, the first sending module 304 sends the coordinates of the current position of the user to the control computer 16 through the network module (e.g., a WiFi module) 33 of the handheld device 12. The second receiving module 403 receives the coordinates of the current position of the user from the handheld device 12, produces a second updated electronic map 20 by recording the coordinates of the current position of the user on the first updated electronic map 19, and sends the second updated electronic map 20 to the handheld device 12.

In step S35, the first receiving module 305 receives the second updated electronic map 20 from the control computer 16 through the network module 33, and displays the second updated electronic map 20 on the first display device 30 of the handheld device 12. The second updated electronic map 20 records the number of moving objects at each monitored area and also indicates the current position of the user.

In step S36, the selection module 301 determines if the user manually selects a route on the second updated electronic map 20. If the user manually selects a route on the second updated electronic map 20, the procedure ends. If the user does not manually select a route on the second updated electronic map 20, the procedure goes to step S37.

In step S37, the selection module 301 receives a planning function instruction selected by the user of the handheld device 1.

In step S38, the first setting module 302 receives an end position input on the second updated electronic map 20 by the user.

In step S39, the first sending module 304 sends the end position to the control computer 16 through the network 14.

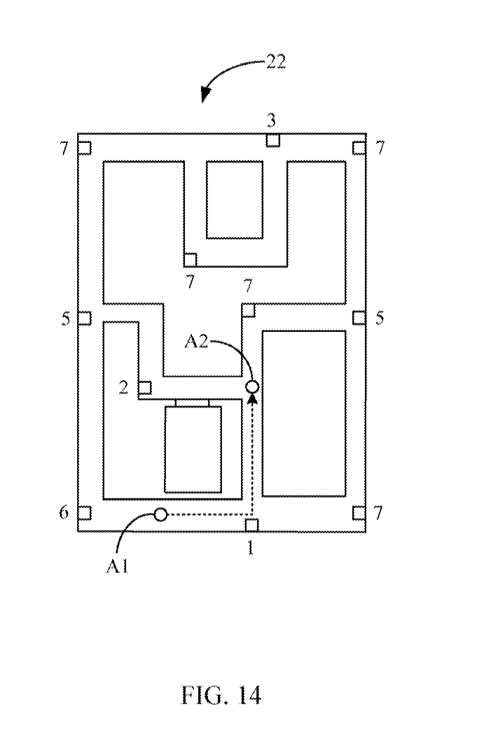

In step S40, the second receiving module 403 receives the end position from the handheld device 12. The route planning module 405 determines an optimized route from the current position of the user to the end position, and produces a fourth updated electronic map 22 by recording the optimized route on the second updated electronic map 20. Then, the second sending module 404 sends the fourth updated electronic map 22 to the handheld device 12 through the network 14. In some embodiments, the route planning module 405 may highlight the optimized route on the fourth updated electronic map 22. For example, as shown in FIG. 14, the broken line from the current position “A1” of the user to the end position “A2” represents the optimized route.

The first receiving module 305 receives the fourth updated electronic map 22 from the control computer 16, and displays the fourth updated electronic map 22 on the first display device 30. As described above, the fourth updated electronic map 22 records the optimized route from the current position of the user to the end position. In one embodiment, the optimized route is a planned route which includes the lowest number of moving objects from the current position of the user to the end position.

It should be emphasized that the above-described embodiments are merely examples of implementations, and are set forth for a clear understanding of the principles of the disclosure. Many variations and modifications may be made to the above-described embodiments without departing substantially from the spirit and principles of the disclosure. All such modifications and variations are intended to be included within the scope of the disclosure.

What is claimed is:

1. A computer-implemented method for planning an optimized route on an electronic map using a handheld device comprising a processor, the method comprising:
receiving a route planning function instruction selected by a user of the handheld device;
receiving a first updated electronic map from a control computer, the first updated electronic map recording a number of moving objects actually at the physical location of each of a plurality of monitored areas that are represented on the electronic map;
receiving a start position and an end position input on the first updated electronic map by the user;
sending the start position and the end position to the control computer; and
receiving a second updated electronic map from the control computer, and displaying the second updated electronic map on a display device of the handheld device, the second updated electronic map recording an optimized route from the start position to the end position.

2. The method according to claim 1, wherein the optimized route is a planned route which comprises the lowest number of moving objects from the start position to the end position.

3. A computer-implemented method for planning an optimized route on an electronic map using a control computer comprising a processor, the method comprising:
recording positions of a plurality of image capturing devices actually at the physical locations of each of a plurality of monitored areas that are represented on the electronic map;
obtaining an image of the monitored area captured by each of the plurality of image capturing devices periodically, detecting a number of moving objects in the obtained image, and producing a first updated electronic map, the first updated electronic map recording the number of moving objects at each monitored area;
receiving from a handheld device a start position and an end position for the first updated electronic map;
determining an optimized route from the start position to the end position, and producing a second updated electronic map by recording the optimized route on the first updated electronic map; and
sending the second updated electronic map to the handheld device.

4. The method according to claim 3, wherein the optimized route is a planned route which comprises the lowest number of moving objects from the start position to the end position.

5. The method according to claim 3, wherein the moving objects are detected using at least one of a vehicle license plate recognition method and a pedestrian detection method.

6. A control computer, comprising:
a storage device;
at least one processor; and
one or more modules that are stored in the storage device and executed by the at least one processor, the one or more modules comprising:
a setting module that sets positions on an electronic map of a plurality of image capturing devices at a plurality of monitored areas, the image capturing devices being actually at the physical locations of the monitored areas that are represented on the electronic map;
a moving object detection module that obtains an image of the monitored area captured by each of the image capturing devices periodically, detects a number of moving objects in the obtained image, and produces a first updated electronic map, the first updated electronic map recording the number of moving objects at each monitored area;
a receiving module that receives coordinates of a current position of a user from a handheld device, and produces a second updated electronic map by recording the coordinates of the current position of the user on the first updated electronic map;
a sending module that sends the second updated electronic map to the handheld device; and
a route planning module;
wherein the receiving module further receives from the handheld device an end position input on the second updated electronic map;
the route planning module determines an optimized route from the current position of the user to the end position, and produces a third updated electronic map by recording the optimized route on the second updated electronic map; and
the sending module further sends the third updated electronic map to the handheld device.

7. The control computer according to claim 6, wherein the optimized route is a planned route which comprises the lowest number of moving objects from the current position of the user to the end position.

8. The control computer according to claim 6, wherein the moving objects are detected using at least one of a vehicle license plate recognition method and a pedestrian detection method.
